(19) United States
(12) Patent Application Publication
(10) Pub. No.: US 2009/0046209 A1
(43) Pub. Date: Feb. 19, 2009

(54) MULTI-VIDEO/AUDIO PURPOSE PORTABLE ELECTRONIC DEVICE

(75) Inventor: RAY L. LU, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EGALAX_EMPIA TECHNOLOGY INC., TAIPEI CITY (TW)

(21) Appl. No.: 11/839,875

(22) Filed: Aug. 16, 2007

(51) Int. Cl. H04N 5/50

(52) U.S. Cl. 348/731; 348/E05.097

(57) ABSTRACT

Described is a multi-video/audio purpose portable electronic device which is capable of providing both TV and broadcast functions, and even a storage function. By using the multi-video/audio purpose portable electronic device, a user can watch or listen to a TV/broadcast program received externally, store the TV/broadcast program and watch the stored TV/broadcast program on different computers at different locations. In addition, an application software necessary for operating the portable electronic device on the computer may be directly stored in the portable electronic device itself. As such, a promoted convenience and lower cost are achieved for the multi-video/audio purpose portable electronic device.

### BACKGROUND OF THE INVENTION

1. Field of the Invention

The present invention relates to a portable electronic device and particularly to a multi-video/audio purpose portable electronic device.

2. Description of the Related Art

As the electronic technology greatly proceeds, universal serial bus (USB) interface has been developed for computer, which is an interface for the computer to have a peripheral electronic device or peripheral electronic devices connect thereto and work therewith, so that a specific function or functions can be achieved thereon. The electronic device(s) connecting to the computer is/are equipped with the so-called plug-and-play function and the electronic devices are connected in series in this configuration.

Portable electronic device is one form of the peripheral electronic devices and may be connected to the computer for a specific purpose via one of various kinds of interfaces, particularly the USB interface. The portable electronic device includes, but is not limited to, digital camera, MP3 player, personal digital assistant (PDA), cellular phone, portable digital TV card, one inch mini hard drive, EZ-drive, etc. The content associated with the portable electronic device can be written from or uploaded to the computer connected therewith via the interface therebetween, thereby achieving the specific function.

Since the computer is capable of mass storage and strong data processing, the portable electronic device connected thereto can be benefited with control from the computer when working together therewith. Further, since the portable electronic device can be carried in hand, it has enjoyed a popularity in market. However, there are many kinds of function-specific portable electronic devices. At this time, a user has to pay a high cost and inconvenience if he/she desires to have several kinds of the portable electronic devices.

The followings will be dedicated to introduction of one of such portable electronic devices, with reference to FIG. 1.

The portable TV card is a device through which the user can watch a TV program on a computer when the portable TV card is connected to the computer. FIG. 1 is a schematic diagram illustrating how the portable TV card works with the computer. As shown, the portable TV card 10 is connected to an external computer 15 and comprises a hybrid TV tuner module 11, a digital demodulation module 12, an analog decoding module 13 and a hybrid TV processing module 14. The hybrid TV processing module 14 comprises a digital processing interface 141, an analog processing interface 142 and a USB interface 143. The computer 15 comprises an application software (not shown) for accessing the portable TV card 10 at least including beginning or stopping a TV program on the portable TV card 10.

When a user plays a TV program on the computer 15 by executing the application software thereon, the hybrid TV tuner module 11 receives a digital TV signal input TV_digital or an analog TV signal input TV_analog. Then, the hybrid TV tuner module 11 outputs a digital video/audio signal IF1 or an analog video signal input IF2 and an analog audio signal SIF. Each of the digital and analog TV signals TV_digital and TV_analog may be one of a wireless TV signal and a cabled TV signal and comprises a video signal and an audio signal.

Next, the digital demodulation module 12 and analog decoding module 13 receive the digital video/audio signal IF1 or the analog video signal IF2 and the analog audio signal SIF, and demodulates the digital video/audio signal IF1 and decodes the analog video signal IF2 and analog audio signal SIF, respectively. Then, the digital demodulation module 12 and analog decoding module 13 output a demodulated digital video/audio signal TS, and a decoded digital video signal YUV and a decoded digital audio signal I²S/AC-Link, respectively. The decoded digital audio signals I²S and AC-Link are taken from two different digital audio signal systems, respectively, and one of which is employed. Thereafter, the digital processing interface 141 and analog processing interface 142 receive the demodulated digital video/audio signal TS, and the decoded digital video signal YUV and decoded digital audio signal I²S/AC-Link, respectively. Then, a computer interface signal CUSB is outputted from the hybrid TV processing module 14 to the computer 15 connected with the portable TV card 10 through the USB interface 143, in response to the received demodulated digital video/audio signal TS and decoded digital video signal YUV and the decoded digital audio signal I²S/AC-Link.

In addition, a broadcast device is a device through which a user can receive an audio AM/FM broadcast content.

Like other portable electronic devices, the above described portable TV card and broadcast device each have its own purpose. Although the portable TV card and broadcast device are related video and/or audio recreation, the portable TV card and broadcast device can only be used separately and the hardware and software required should be provided separately. In this case, the cost and use for the functions cannot be low and convenient. And these devices may even seek a wider range of functions. Therefore, there is a need to provide a multi-video/audio purpose portable electronic device t satisfy the user's demand.

### SUMMARY OF THE INVENTION

It is, therefore, an object of the present invention to provide a multi-video/audio purpose portable electronic device, so that cost thereof can be lowered and user convenience thereof can be enhanced.

In accordance with the present invention, the multi-video/audio purpose portable electronic device comprises a broadcast module, a TV module, and a hybrid processing module. The broadcast module receives a broadcast signal and outputs a to-be-processed broadcast signal in response thereto. In the TV module, the hybrid TV tuner unit receives one of an external digital TV signal and an external analog TV signal each comprising a video signal and an audio signal, and outputs one of a digital video/audio signal, and an analog video signal and an analog audio signal in response thereto. The digital demodulation unit receives the digital video/audio signal and outputs a demodulated digital video/audio signal in response thereto. The analog decoding unit receives the analog video and audio signals and outputting a decoded digital video signal and a decoded digital audio signal in response thereto. The hybrid processing module comprises a digital processing interface receiving the demodulated digital video/audio signal, an analog processing interface receiving the decoded digital video and audio signals, and a universal serial bus (USB) interface connected to an external computer.

In operation, the multi-video/audio purpose portable electronic device is enabled by a command by a user from the external computer to play on the external computer a first content corresponding to a first computer interface signal on the USB interface by receiving the first computer interface signal from the external computer through the USB interface according to the received demodulated video/audio signal, the decoded digital video and audio signals, and the broadcast signal.

In an embodiment, the hybrid processing module further comprises a storage interface and the multi-video/audio purpose portable electronic device further comprises a storage module connected through a data/address bus to the storage interface, wherein the multivideo-purpose portable electronic device is further enabled by another command by the user to execute one of the following actions: the external computer includes an application software comprising a TV portion associated with the TV module and a broadcast portion associated with the broadcast module, and storing the first content corresponding to a second computer interface signal on the USB interface through the storage interface and the data/address bus to the storage module, acquiring a second content corresponding to a third computer interface signal on the USB interface from the external computer from the storage module through the storage interface onto the external computer, and playing the acquired second content corresponding to a fourth computer interface signal on the USB interface on the external computer.

By means of the multi-video/audio purpose portable electronic device, a user can watch or listen to a TV/broadcast program received externally, store the TV/broadcast program in a single portable electronic device and watch or listen to the stored TV/broadcast program on different computers at different locations. Further, an application software necessary for operating the multi-video/audio purpose portable electronic device on the computer may be directly stored in the portable electronic device itself. As such, a promoted convenience and lower cost are achieved by the multi-video/audio purpose portable electronic device.

### BRIEF DESCRIPTION OF THE DRAWINGS

The above and other objects of the present invention will become readily apparent by reference to the following detailed description when considered in conjunction with the accompanying drawings wherein:

FIG. 1 is a block diagram illustrating how a conventional portable TV card works with a computer;

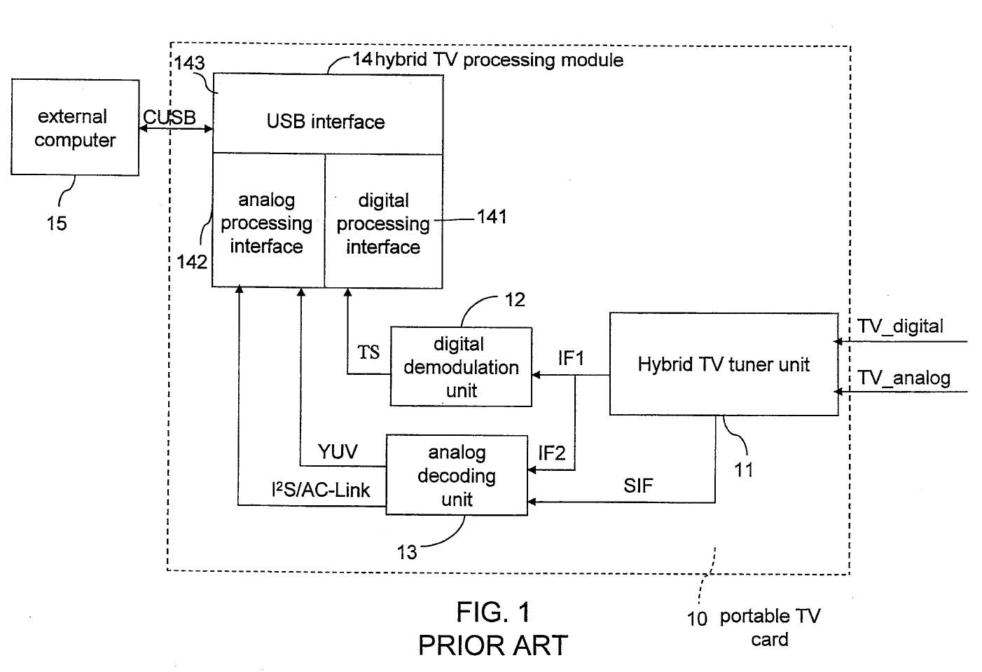

FIG. 2 is a block diagram illustrating how a multi-video/audio purpose portable storage device works with a computer in response to the present invention.

### DETAILED DESCRIPTION OF THE INVENTION

The present invention is a multi-video/audio purpose portable electronic device, which can provide a TV and broadcast (or radio) functions concurrently and will be described taken in the preferred embodiments with reference to the accompanying drawings.

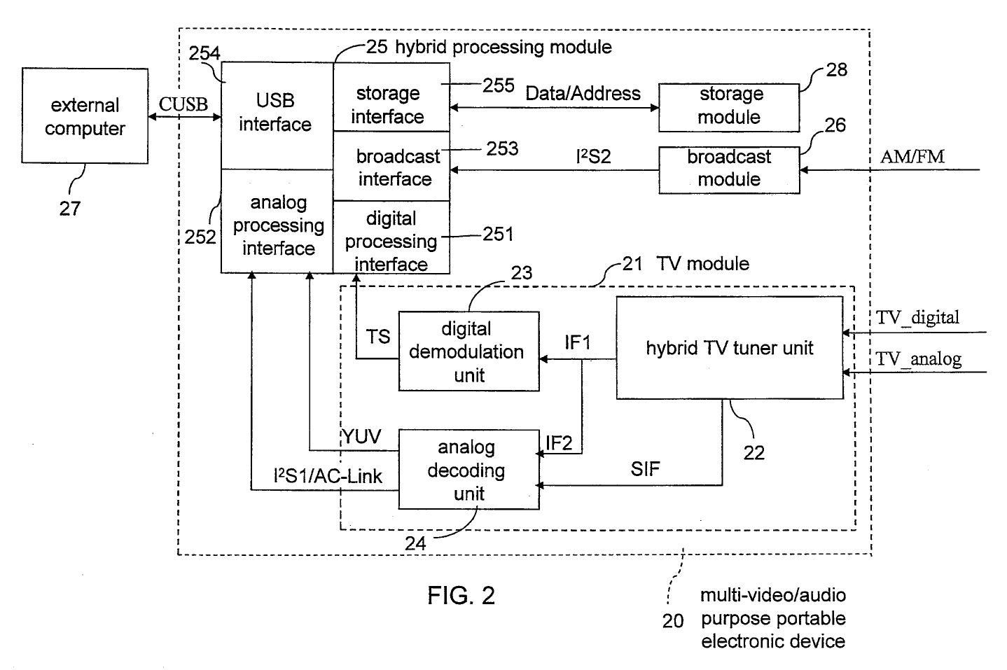

Referring to FIG. 2, the multi-video/audio purpose portable electronic device 20 is connected to an external computer 27 and comprises a TV module 31, a hybrid processing module 25 and a broadcast module 26. Among them, the TV module 21 is associated with the TV function while the broadcast module 26 with the broadcast function. The hybrid processing module 25 is provided to communicate both the TV and broadcast modules 31 and 26 with the computer 27. The computer 27 comprises an application software (not shown) for accessing the multi-video/audio purpose portable electronic device 20. The application software comprises a TV portion and a broadcast portion, corresponding to an execution of the TV and PC cam functions, respectively.

In the multi-video/audio purpose portable electronic device 20, the TV module 21 comprises a hybrid TV tuner unit 22, a digital demodulation unit 23 and an analog decoding unit 24. Specifically, the TV module 21 further comprises an antenna (not shown) and a cable interface (not shown). The TV module 21 receives the wireless TV signal and the cable TV signal through the antenna and an external cable connected to the cable interface, respectively. The hybrid processing module 25 comprises a digital processing interface 251, an analog processing interface 252, a broadcast interface 253 and a universal serial bus (USB) interface 254.

When a user executes a command “play” on the TV portion of the application software on the computer 27, the hybrid TV tuner unit 22 in the TV module 21 receives an external digital TV signal TV_digital or an external analog TV signal TV_analog. Each of the external digital and analog TV signals TV_digital and TV_analog may be a wireless TV signal or a cabled TV signal and comprises a video signal and an audio signal. In response to the external digital or analog TV signals TV_digital and TV_analog, the hybrid TV tuner unit 22 outputs a digital video/audio signal IF1, or an analog video signal IF2 and an analog audio signal SIF.

The digital demodulation unit 23 is used to receive the digital video/audio signal IF1 and output a demodulated digital video/audio signal TS in response to the received digital video/audio signal IF1.

The analog decoding unit 24 is used to receive the analog video signal IF2 and the analog audio signal SIF, and then output a decoded digital video signal YUV in response to the analog video signal IF2 and a decoded digital audio signal I²S1/AC-Link in response to the analog audio signal SIF.

When the user executes a command “play” on the broadcast portion of the application software on the computer 27, the broadcast module 26 receives a broadcast signal AM/FM from outside and then outputs a digital audio signal I²S2. It is to be noted that the decoded digital audio signals I²S1 and AC-Link of the illustrated signal I²S1/AC-Link are taken from two different digital audio signal systems, respectively, and one of which is adopted.

No matter which one of the “play” and “broadcast” functions is executed at the application software end, the hybrid processing module 25 receives the demodulated digital video/audio signal TS, the demodulated digital video signal YUV, the decoded digital audio signal I²S1/AC-Link and the digital audio signal I²S2. Specifically, the demodulated digital video/audio signal TS is outputted to the digital processing interface 251. The demodulated digital video signal YUV and the decoded digital audio signal I²S1/AC-Link are outputted to the analog processing interface 252. The digital audio signal I²S2 is outputted to the broadcast interface 253.

In response, the hybrid processing module 25 outputs a computer interface signal CUSB to the computer 27 in response to the demodulated video signal YUV, the decoded digital audio signals I²S1/AC-Link and the digital audio signal I²S2. In this manner, since the multi-video/audio purpose portable electronic device 20 and the computer 27 are in communication via the CUSB signal in both video and audio components, the TV and broadcast functions of the device 20 can be executed at the computer 27 through the application software thereon. For instance, when the TV function is activated, i.e. the “play” command associated therewith is sent, a TV program is played on the computer (more accurately on a display (not shown) associated with the computer) 28. On the other hand, when the broadcast function is otherwise activated, i.e. the “play” command associated therewith is sent, the broadcast signal AM/FM is received and a corresponding broadcast content is played on the computer 27. Of course, commands such as “stop” is also provided, so that the user may choose to stop the video content or the audio content to be played on the computer 27.

Preferably, the multi-video/audio purpose portable electronic device 20 is additionally provided with a storage module 28. Specifically, the storage module 28 is connected to an additional storage interface 255 of the hybrid processing module 25 via a data/address bus Data/Address, on which a data/address signal associated with the video and audio content is transmitted. At this time, the application software on the computer 27 further has a command “store” and a command “acquire and play” for the user, so that the user may execute the command “store” to store the externally received video and audio content and the command “acquire and play” to acquire the video and audio content from the storage module 28 and then play the acquired video and audio content on the computer 27, through the computer interface CUSB. Although the commands “play”, “stop”, “store” and “acquire and play” are exemplified, the exact commands may not be thus defined. All the commands equivalent to those described above and associated with the application software should be contemplated in the present invention.

The storage module 28 may be a one inch mini hard drive or a flash memory. The flash memory 28 is integrally formed with the multi-video/audio purpose portable electronic device 20 while the small sized portable hard disk drive 28 is integrally formed with or detachable from the multi-video/audio purpose portable electronic device 20. The one inch mini hard drive 28 is described as “detachable” simply because it has a standard connector and the multi-video/audio purpose portable electronic device 20 also comprises a standard connector complemented thereto, which the standard connector of the one inch mini hard drive 28 may be connected to or detached from. Further, the storage module 28 may also be a card reader and a card readable by the card reader. At this time, the card reader 28 is integrally formed with or detachable from the portable electronic device 20 and the card is inserted into the multi-video/audio purpose portable electronic device 20 in operation.

In addition, the application software is conventionally contained in an optical disk (not shown), so that the user may install the application software into the computer 27 by accessing the optical disk. However, the application software may be stored directly in the storage module 28 of the multi-video/audio purpose portable electronic device 20 in the present invention and thus do without the existence of the optical disk. At this time, if the user desires to re-install the application into the computer 27, he/she may finish the job with the aid of the storage module 28 and does not take any risk of loss of the optical disk and need to locate where the optical disk has been put or worry about if the optical disk is hard to be re-acquired. Accordingly, the use of the multi-video/audio purpose portable electronic device 20 is provided a good convenience.

Therefore, a user can watch or listen to a TV/broadcast program received externally, store the TV/broadcast program in a single portable electronic device and watch the stored TV/broadcast program on different computers at different locations. In addition, an application software necessary for operating the portable electronic device on the computer may be directly stored in the portable electronic device itself. As such, a promoted convenience and lower cost are achieved for the multi-video/audio purpose portable electronic device.

The above mentioned signals TV_signal, TV_analog, IF1, IF2, TS, YUV, I²S1/AC-Link, I²S2, Data/Address, AM/FM and CUSB are apparent to those skilled in the art and will be omitted herein for clarity.

By performing the present invention, the user may execute more than one function by connecting a single portable electronic device to a computer, effectively enhancing the user convenience in terms of the desirable functions. Further, the hardware and firmware necessary for implementation of the conventional portable TV card and broadcast device may be shared in the inventive multi-video/audio purpose portable electronic device. Moreover, the respective housings used for the conventional portable TV card and broadcast device and even the portable storage device can be reduced in cost in the present invention in terms of the same TV and broadcast and even the storage functions.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A multi-video/audio purpose portable electronic device, comprising:
a broadcast module receiving a broadcast signal and outputting a to-be-processed broadcast signal in response thereto;
a TV module, comprising:
a hybrid TV tuner unit receiving one of an external digital TV signal and an external analog TV signal each comprising a video signal and an audio signal, and outputting one of a digital video/audio signal, and an analog video signal and an analog audio signal in response thereto;
a digital demodulation unit receiving the digital video/audio signal and outputting a demodulated digital video/audio signal in response thereto; and
an analog decoding unit receiving the analog video and audio signals and outputting a decoded digital video signal and a decoded digital audio signal in response thereto;
a hybrid processing module comprising:
a digital processing interface receiving the demodulated digital video/audio signal;
an analog processing interface receiving the decoded digital video signal and the first and second decoded audio signal;
a broadcast interface receiving the to-be-processed broadcast signal; and
a USB interface connected to an external computer,
wherein the multi-video/audio purpose portable electronic device is further enabled by a command by a user from the external computer to play on the external computer a first content corresponding to a first computer interface signal on the USB interface by receiving the first computer interface signal on the USB interface through the USB interface according to the received demodulated video/audio signal, the decoded digital video and audio signals, and the broadcast signal.

2. The multi-video/audio purpose portable electronic device as claimed in claim 1, wherein the external computer includes an application software comprising a TV portion associated with the TV module and a broadcast portion associated with the broadcast module, and the user plays the first content on the external computer by sending the command corresponding to one of the TV portion and the broadcast portion on the application software, to the multi-video/audio purpose portable electronic device, and when the TV potion is activated by the command the first content is a TV program content, while when the broadcast portion is activated by the command the first content is a broadcast program content.

3. The multi-video/purpose portable electronic device as claimed in claim 1, wherein each of the external digital and analog TV signals is one of a wireless TV signal and a cabled TV signal.

4. The multi-video purpose portable electronic device as claimed in claim 3, wherein the TV module further comprises an antenna receiving the wireless TV signal and a cable interface receiving the cable TV signal through an external cable connected thereto, respectively.

5. The multi-video/audio purpose portable electronic device as claimed in claim 1, wherein the hybrid processing module further comprises a storage interface and the multi-video/audio purpose portable electronic device further comprises a storage module connected through a data/address bus to the storage interface, wherein the multi-video/audio purpose portable electronic device is further enabled by another command by to execute one of the following actions: the multivideo-purpose portable electronic device is further enabled by another command by the user to execute one of the following actions: storing the first content corresponding to a second computer interface signal on the USB interface through the data/address bus to the storage module, acquiring a second content corresponding to a third computer interface signal on the USB interface from the storage module through the storage interface onto the external computer, and playing the acquired second content corresponding to a fourth computer interface signal on the USB interface on the external computer.

6. The multi-video/audio purpose portable electronic device as claimed in claim 5, wherein the external computer includes an application software comprising a TV portion associated with the TV module and a broadcast portion associated with the broadcast module, and the user stores and acquires the second content and plays the stored second content by sending the command corresponding to one of the TV portion and the broadcast portion on the application software, to the multi-video/audio purpose portable electronic device, and when the TV potion is activated by the another command the first content is a TV program content, while when the broadcast portion is activated by the another command the second content is a broadcast program content.

7. The multi-video/audio purpose portable electronic device as claimed in claim 6, wherein the application software is stored in the storage module before being installed into the external computer.

8. The multi-video/audio purpose portable electronic device as claimed in claim 5, wherein the storage module is selected from the group consisting of a one inch mini hard drive and a flash memory.

9. The multi-video/purpose portable electronic device as claimed in claim 8, wherein the flash memory is integrally formed with the portable electronic device and the small sized portable hard disk drive is integrally formed with or detachable from the portable electronic device.

10. The multi-video/audio purpose portable electronic device as claimed in claim 8, wherein the storage module further comprises a card reader and a card readable by the card reader.

11. The multi-video/audio purpose portable electronic device as claimed in claim 10, wherein the card reader is integrally formed with or detachable from the multi-video/audio portable electronic device.

12. The multi-video/purpose portable electronic device as claimed in claim 5, wherein each of the external digital and analog TV signals is one of a wireless TV signal and a cabled TV signal.

13. The multi-video purpose portable electronic device as claimed in claim 12, wherein the TV module further comprises an antenna receiving the wireless TV signal and a cable interface receiving the cable TV signal through an external cable connected thereto, respectively.
